(19) United States
(12) Patent Application Publication
(10) Pub. No.: US 2007/0133385 A1
(43) Pub. Date: Jun. 14, 2007

(54) Reverse ID class inference via auto-grouping

(75) Inventors: Hank D. J. Hoek, Kirkland, WA (US); Venkata N. Padmanabhan, Sammamish, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/304,843

(22) Filed: Dec. 14, 2005

(51) Int. Cl. H04J 3/10

(52) U.S. Cl. 370/201

(57) ABSTRACT

Class information is leveraged to facilitate in grouping identifications (ID) to allow ID range-to-class mapping information to be determined. ID range-to-class inference techniques are employed to determine similarities of IDs associated with a class, creating ID range-to-class mapping. Identifications can include Internet Protocol (IP) addressing, telephone numbers, and other sequenceable forms of identification for users and/or computing devices. Classes can include user location, age, income, gender, language, and/or other classifications. Thus, IP address ranges, for example, can be mapped to user geographic locations using an inference technique, specifically a “GeoInference” technique. The inference techniques quickly detect IP proxy usage and identify and eliminate outliers within a given IP range, substantially increasing the accuracy of user location data. Complementary data sources can be employed to facilitate in increasing data accuracy.

### BACKGROUND

Oftentimes, it is desirable to tailor a user's computing experience to their location. Knowing a user's location allows the computing environment to be modified accordingly. Thus, users can have a more satisfying experience by making the computing interaction a function of the user's location as well as other factors. For example, faxes can be routed to a particular nearby printer or fax machine. A user can search for “pizza” and have only local listings appear rather than listings that include pizza restaurants all over the world. Price searches could be automatically limited based on local area pricing such as for automobile pricing and the like.

User location knowledge is especially useful when the computing device is typically stationary such as a desktop computer. These types of computing devices are generally connected to the Internet via a wired means such that they are not easily transportable. Thus, their location is usually stable and can be exploited for use with the Internet. For example, a user browsing information on a news web site might have the information customized based on their locale. Localized events, weather, and activities can be presented to the user. Likewise, advertisements can be targeted based on the geographical location of the user. Filtering of information can also be employed based on location of a user. This is typically utilized for broadcasting that is limited to only certain areas and the like.

In general, the granularity of the user's location information can be quite coarse and still be effective. However, while various techniques have been developed for determining a user's location, with fine or coarse resolution, they still exhibit a high likelihood of errors when associating host identifiers such as IP addresses and/or Domain Name System (DNS) names and the like with a user's location. This often occurs because the Internet ID means employed is the Internet Protocol (IP) address which can be masked utilizing proxies. With proxies, many users will appear to be located in a single location. This is because the users connect to the Internet via a single IP address provided by, for example, an Internet content provider.

Traditional solutions for solving user locations can be typically classified into three categories for the Internet; domain name service approaches, whois database approaches, and traceroute approaches. The first approach includes incorporating latitude and longitude information in the domain name service (DNS). However, there is no easy way to verify whether the location entered by a user or administrator is accurate. The second approach involves using the whois database to determine the location of the organization to which an IP address is allocated. However, the whois database is often inconsistent and highly unreliable. In addition, a large block of IP addresses may be allocated to a single entity, masking multiple user locations. The third approach involves performing a traceroute function to an IP address and mapping the router label to the geographic location. However, traceroute-based approaches suffer from unavailable information and inconsistent labeling that can cause ambiguities.

Thus, the fundamental problems with using IP addresses to estimate user locations include location masking by proxy usage and inaccurate information. In some cases, the inaccurate information is obtained directly or indirectly from the users themselves. A user can log into a web site where they have pre-registered on a computing system in another country. This might cause the IP address to be associated with their hometown instead of their actual current location. Inaccuracies can also be caused deliberately. Either way, it substantially reduces the accuracy of the IP mapping information. Therefore, when this information is utilized in location-aware processes, the user is very dissatisfied with the experience because the interaction is based on the wrong user location.

### SUMMARY

The following presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

The subject matter relates generally to data mining, and more particularly to systems and methods for grouping identifications (IDs) based on a class distribution. Class information is leveraged to facilitate in grouping identifications to allow ID range-to-class mapping information to be determined. ID range-to-class inference analysis techniques are employed to determine similarities of IDs associated with a class, creating ID range-to-class mapping. Identifications (IDs) can include, but are not limited to, Internet Protocol (IP) addressing, telephone numbers, and other sequenceable forms of identification for users and/or computing devices. IDs can also include sequenceable strings such as names. Classes can include, but are not limited to, user location, age, income, gender, language, and/or other classifications that can be correlated to IDs.

Thus, for example, IP address (i.e., ID) ranges can be mapped to user geographic locations (i.e., class) using an inference technique, specifically a “GeoInference” technique. Likewise, for example, telephone numbers can be mapped to user geographic locations using an inference technique as well. The inference techniques quickly detect IP proxy usage and identify and eliminate outliers within a given IP range, substantially increasing the accuracy of user location data. Complementary data sources can be employed as well to facilitate in increasing data accuracy. Thus, for example, location-aware applications, such as, for example, advertisement applications can dramatically increase their target accuracy utilizing inference-based information.

To the accomplishment of the foregoing and related ends, certain illustrative aspects of embodiments are described herein in connection with the following description and the annexed drawings. These aspects are indicative, however, of but a few of the various ways in which the principles of the subject matter may be employed, and the subject matter is intended to include all such aspects and their equivalents. Other advantages and novel features of the subject matter may become apparent from the following detailed description when considered in conjunction with the drawings.

### BRIEF DESCRIPTION OF THE DRAWINGS

FIG. 1 is a block diagram of an ID range-to-class inference system in accordance with an aspect of an embodiment.

FIG. 2 is another block diagram of an ID range-to-class inference system in accordance with an aspect of an embodiment.

FIG. 3 is yet another block diagram of an ID range-to-class inference system in accordance with an aspect of an embodiment.

FIG. 4 is an illustration of an example process of user IP range-to-location inference in accordance with an aspect of an embodiment.

FIG. 5 is a flow diagram of a method of facilitating ID range-to-class inference in accordance with an aspect of an embodiment.

FIG. 6 is a flow diagram of a method of facilitating IP range-to-class inference for web log data in accordance with an aspect of an embodiment.

FIG. 7 is a flow diagram of a method of facilitating IP range-to-class inference based on IP octets in accordance with an aspect of an embodiment.

FIG. 8 is a flow diagram of a method of facilitating ID range-to-class inference hybrid mapping data in accordance with an aspect of an embodiment.

FIG. 9 illustrates an example operating environment in which an embodiment can function.

FIG. 10 illustrates another example operating environment in which an embodiment can function.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It may be evident, however, that subject matter embodiments may be practiced without these specific details. In other instances, well-known structures and devices are shown in block diagram form in order to facilitate describing the embodiments.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers.

Instances of the systems and methods disclosed herein can be applied generically to various classifications utilizing various sequenceable identification means to yield identification (ID) ranges for a given class distribution. Although ID and class can be arbitrary in general, IP addresses and location are utilized as examples to facilitate ease of exposition. For example, in a web context, it is often desirable to know the user's location. A large national fast food chain restaurant might be able to afford to display web advertisements indiscriminately, but a locally-owned sole proprietorship would need to be able to limit its target audience to the immediate area. Unfortunately, many commercially available reverse-IP maps might contain gross errors and demonstrate poor accuracy. Instances of the systems and methods herein improve the correctness and accuracy of, for example, IP-based user-location mapping by utilizing correlation-analysis of web-logs to generate high quality reverse-IP maps.

In one instance, log-records that correlate IP with some independent source of location information are obtained. This type of data can include, for example, registration and/or login records at a web portal such as an email service and/or searches at an online web site and the like. This type of data is often incomplete and/or contains inaccuracies. The records are then sorted by IP and then an inference technique, denoted as “GeoInference,” is applied to build IP-range groupings of similar geographic distributions. Next, the groupings are analyzed for metric measures such as, for example, centroid, mean error-radius and/or confidence factor and the like. The groupings can optionally be combined with complementary sources of reverse-IP mapping data (i.e., similar mappings derived from alternate sources of data, potentially via alternate methods). The mapping data can then be stored for later use. For proxy IP's, such as those used by online content providers, where accurate location inference is obviously impossible, instances of the systems and methods herein are capable of correctly identifying these locations as “unknown.”

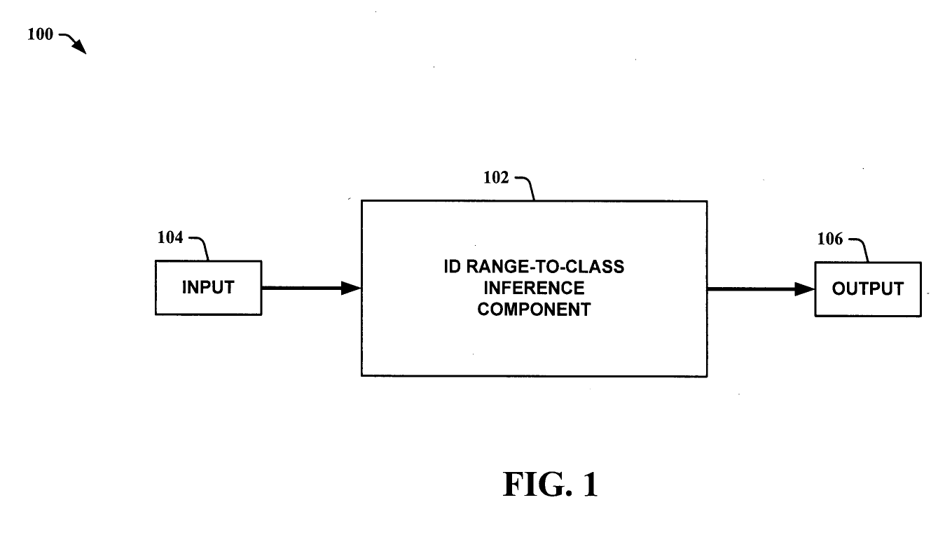

In FIG. 1, a block diagram of an ID range-to-class inference system 100 in accordance with an aspect of an embodiment is shown. The ID range-to-class inference system 100 is comprised of an ID range-to-class inference component 102 that receives an input 104 and provides an output 106. The input 104 generally consists of class information and associated identification (ID) information. Classes can include, but are not limited to, user location, age, income, gender, language, and/or other classifications. Identifications (IDs) can include, but are not limited to, Internet Protocol (IP) addressing, telephone numbers, and/or other sequenceable forms of identification for users and/or computing devices. For example, given a national or global phone-book, lastName, firstName can be utilized as a key, and a prefix (e.g., “206”) can be utilized as a proxy for a location. Even some family names can be employed if they correlate strongly to a location. The input 104 can include, for example, Internet web log information and the like. Thus, when a user registers for web site access and the like, the information can be obtained by the ID range-to-class inference component 102.

The ID range-to-class inference component 102 employs correlation analysis to infer like ID ranges based on a class. If a user has deliberately disclosed their class (e.g., location) falsely, this can become apparent over a range of IDs (e.g., IP address range groupings can predominantly disclose another location for the user, negating a single outlier in the data). Similar cleaning of the data occurs even when incorrect information is not deliberately disclosed (e.g., a user logs into another computer and inputs their hometown even though the IP is for a different city). The ID range-to-class inference component 102 can provide high quality reverse-ID maps as the output 106. In other instances, the output 106 can also be comprised of metrics (e.g., confidence data, error data, other statistical information, etc.) for the mapping data as well as other associated information.

In essence, the ID range-to-class inference system 100 finds ranges of IDs that contain similar class information by comparing neighboring ID ranges. The similarity measure can include a single measurement or multiple measurements. One instance employs an isLike function to facilitate in determining similarity. An isLike function is an expression returning a similarity measure comparing candidate clusters. Typical usage in an ID range-to-class inference system maps the similarity measure to a Boolean used to determine whether adjoining candidate clusters should be merged into a single cluster corresponding to a single class. Mappings of ID ranges-to-classes are particularly useful in systems that target users based on their class such as, for example, their location. Quite often these systems include advertising services that direct advertisements at users based on geographic location. This type of information allows the advertising services to charge advertisers more for targeted advertisements.

Similarly, the ID range-to-class inference system 100 can be employed to support enhanced search and/or content relevance and/or to discriminate between users regarding services offered and the like. This allows, for example, a search engine to only provide a user with car pricing information for local car dealerships when the user is searching for a car and/or to list only local dry-cleaning pickup services when the user desires to have laundry cleaned and the like. The mapped ID range can correspond to a single user or multiple users (e.g., via a network address translation (NAT) or a proxy).

The ID range-to-class inference system 100 is also useful for determining “unknown” IDs. For example, when a substantial amount of users are associated with a single ID or a similar range of IDs, it is very likely that a proxy is being employed. If the proxy is being utilized by users in a single class (e.g., geographical location), the mapping is still “known.” However, if the proxy is utilized by users in diverse classes (e.g., diverse locations), the mapping is “unknown.” This information can then be used, for example, to segment out unknown proxies to avoid mis-targeted advertisements and the like. This is particularly useful in countries with businesses and the like that utilize a single proxy (or range of proxies) for all users in a large geographic region for Internet usage and the like.

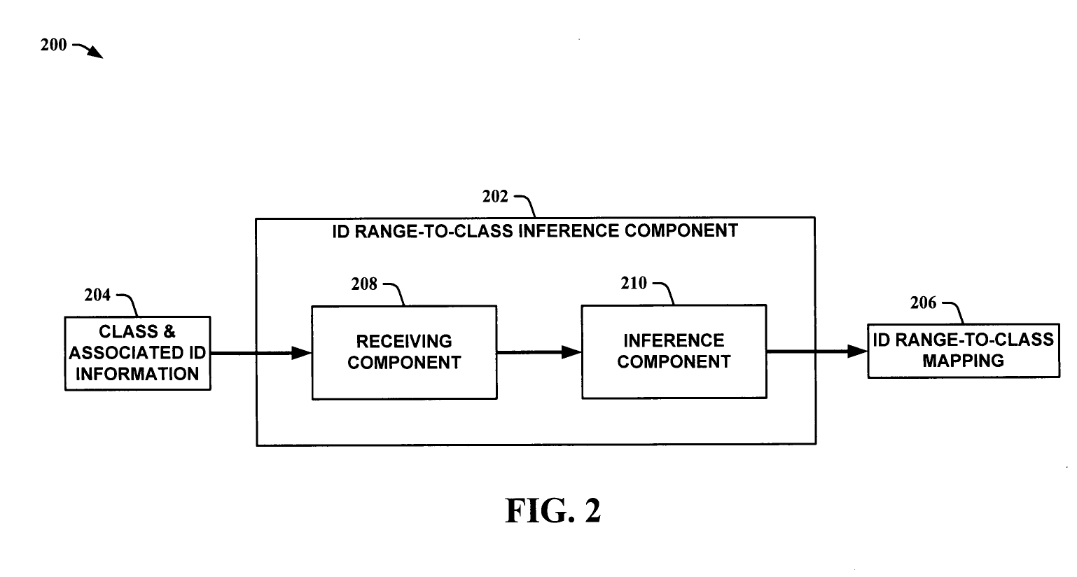

Turning to FIG. 2, another block diagram of an ID range-to-class inference system 200 in accordance with an aspect of an embodiment is depicted. The ID range-to-class inference system 200 is comprised of an ID range-to-class inference component 202 that receives class & associated ID information 204 and provides ID range-to-class mapping 206. The ID range-to-class inference component 202 is comprised of a receiving component 208 and an inference component 210. The receiving component 208 obtains class & associated ID information 204 from a data source such as, for example, web logs, web user data management services, and/or telephone directory services and the like. The receiving component 208 can perform preliminary filtering of the class & associated ID information 204 if required. The inference component 210 then receives the class & associated ID information 204 from the receiving component 208 and employs an inference technique to provide ID range-to-class mapping 206. The inference technique can include, for example, an isLike function that can compare neighboring ID ranges based on a class similarity measure or measures. In this manner, the inference component 210 builds ID range groupings that constitute the ID range-to-class mapping 206. Processes for accomplishing this are discussed in detail infra.

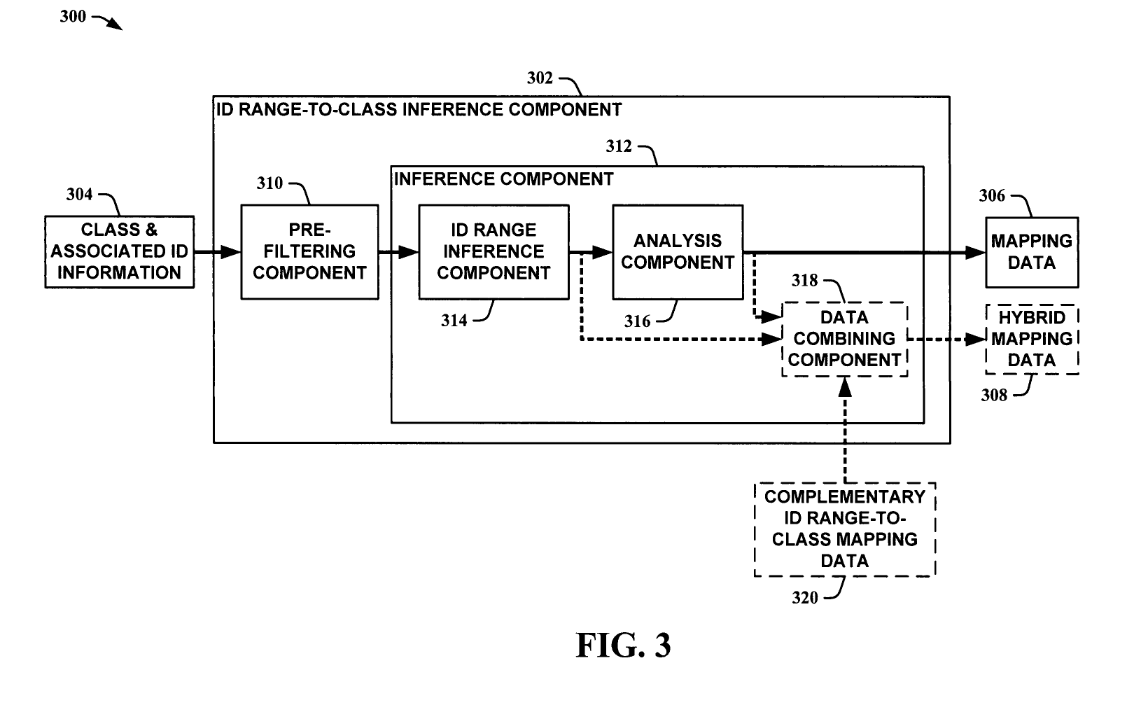

Looking at FIG. 3, yet another block diagram of an ID range-to-class inference system 300 in accordance with an aspect of an embodiment is illustrated. The ID range-to-class inference system 300 is comprised of an ID range-to-class inference component 302 that receives class & associated ID information 304 and provides mapping data 306 and/or optional hybrid mapping data 308. The ID range-to-class inference component 302 is comprised of a pre-filtering component 310 and an inference component 312. The inference component 312 is comprised of an ID range inference component 314, an analysis component 316, and an optional data combining component 318. The pre-filtering component 310 receives the class and associated ID information 304 from a data source and performs sorting and/or filtering when necessary. Some instances do not require the pre-filtering component 310.

The ID range inference component 314 obtains the filtered (or non-filtered) class & associated ID information 304 from the pre-filtering component 310 or directly from a data source. The ID range inference component 314 employs an inference technique to build ID range groupings. For example, an isLike function can be employed by the ID range inference component 314 to evaluate neighboring ID ranges to determine if they meet a class similarity measure or measures. Some instances utilize a single pass inference technique that builds ranges until a similarity ends. The dissimilar range is then used as a seed to compare to neighboring ranges and the process continues. This allows efficient use of memory and/or computational resources. Other instances can store and recall all range groupings in order to compare all grouping combinations.

The analysis component 316 receives the ID range groupings from the ID range inference component 314 and determines metrics by performing statistical analysis on the groupings. The analysis component 316 then provides the ID range groupings and/or the metrics as the mapping data 306. Optionally, a data combining component 318 can be employed to augment the mapping data 306 by utilizing complementary ID range-to-class mapping data 320 to provide the optional hybrid mapping data 308. The optional data combining component 318 can receive ID range groupings directly from the ID range inference component 314 and/or receive the ID range groupings along with metrics from the analysis component 316. The optional data combining component 318 can be implemented to provide missing data with the complementary ID range-to-class mapping data 320 and/or to enhance the ID range groupings and the like. For example, if the ID range groupings determined by the ID range inference component 314 have a low confidence associated with them as determined by the analysis component 316, that particular data can be utilized from the complementary ID range-to-class mapping data 320 if it has a high level of confidence associated with it. One skilled in the art can appreciate that any number of statistical means can be employed to facilitate in providing the optional hybrid mapping data 308 and are within the scope of the systems and methods disclosed herein.

Thus, GeoInference techniques can be utilized to overcome limitations of traditional techniques (e.g., proxies, incomplete traceroutes, etc.). For example, sometimes available reverse-IP maps contain errors and/or have poor accuracy. This has dramatic effects on applications that utilize location information for targeting purposes such as, for example, advertisement applications and, especially, localized advertising. Thus, the user's location can be employed to substantially enhance the targeting of advertisements, to support enhanced search and content-relevance, and/or to discriminate between users regarding services offered and the like. If a significant number of reverse-IP errors can be removed and/or if accuracy can be improved significantly, not only does the quality of dependent services improve, but also new classes of use with lower bounds on acceptable quality become feasible.

Thus, by employing, for example, instances of the systems and methods herein that provide correlation-analysis of, for example, web logs can support generation of high quality reverse-IP maps. These instances, specifically, significantly improve the correctness and accuracy of IP-based user-location mapping over current commercially available data. For proxy IP's, such as those used by, for example, content providers, where accurate location inference is obviously impossible, instances of the systems and methods herein are capable of correctly identifying the location as unknown.

In one instance, log records are gathered that correlate IP with an independent source of location information. These records are then sorted based on the IP. GeoInference is then applied to build IP-range groupings of similar geographic distributions. The groupings can then be analyzed to determine metric measures such as, for example, centroid, mean error-radius, and/or confidence factor and the like. Complementary sources of reverse-IP mapping data can also be combined to facilitate in improving the accuracy of the data. The data can then be made available to applications that employ user location.

Instances of the systems and methods herein can provide direct inference of IP-range groupings of similar geographic distributions. These methods partition the IP namespace solely on the basis of maximal internal consistency of mapped ranges. The inference techniques are equally applicable to other classes besides location such as, for example, income, age, gender, language and/or other classifications available for correlation against IP.

Appropriate direct inference of similar IP-ranges requires adaptation to actual features of the geographical distribution of IP's over the IP namespace. Some of the complexity inherent in the distribution of IP's over the namespace encroaches onto algorithms for effective partitioning, thus, for example, an “isLike” method can be employed as an extension-point in the algorithm necessary for adapting to the empirical features of IP→geography grouping. The isLike method can be an appropriate similarity measure for comparing two candidate groupings and can be used to determine whether they should be merged into a single grouping or tracked separately. Candidate groupings are generated, for example, during a linear scan through the IP namespace by suggesting, for example, that any IP's similar on the first three octets form a candidate grouping, although a smaller range can be chosen if it contains adequate samples.

For single-scan efficiency, a previous candidate grouping can be held in memory, merging a new grouping in if it isLike the previous candidate. Otherwise, the previous candidate is recorded and the new grouping is promoted to previous candidate status. It is desirable to generate some descriptive summary-statistics or metrics for the purpose of applying an appropriate isLike measure to candidate groupings. Statistical summaries are also useful to forget the original user-information, while retaining sufficient information to describe location, confidence, and/or error-radius and the like.

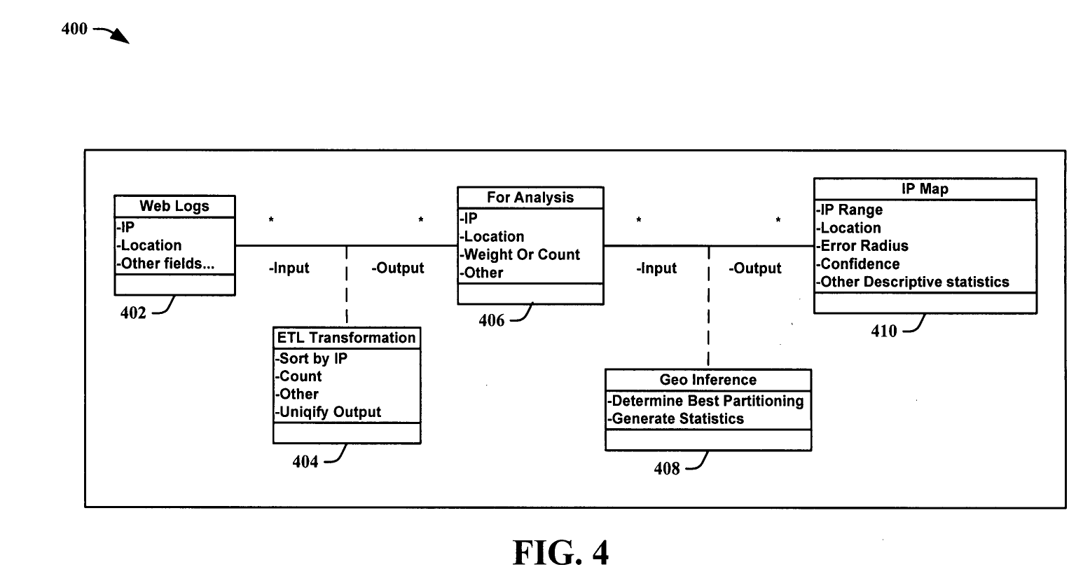

In FIG. 4, an illustration of an example process 400 of user IP range-to-location inference in accordance with an aspect of an embodiment is shown. Web logs 402 are obtained and transformed 404. The transformed web logs are then analyzed 406 and GeoInference is applied 408 to provide an IP map 410. Direct inference of similar IP-ranges can also be efficiently and effectively implemented as follows. Given the following logical input records (sorted by IP ascending): IP (octet1, octet2, octet3, octet4); Country/Zip (or similar location information); Count of Unique Users (or similar usage measure)—this logically includes latitude, longitude, and intrinsic location-error and the like.
A) Join IP's similar in the first three octets up to a maximum user-count into candidate groupings.
B) Join similar candidate groupings if isLike.
C) Report location, confidence, and/or error-radius information for similar groupings.
D) Store and/or utilize this mapping information as typical for a reverse-IP map.

Instances of the systems and methods herein do not depend on border gateway protocol (BGP) data for the initial grouping. This contrasts with co-assigned U.S. patent application entitled “SYSTEM AND METHOD FOR DETERMINING THE GEOGRAPHIC LOCATION OF INTERNET HOSTS,” filed on May 4, 2001 and assigned Ser. No. 09/849,662 (hereinafter referred to as the “662 application”). The '662 application includes a GeoCluster technique utilized for IP location mapping. However, the GeoCluster technique relies on an initial BGP table to provide some structure for an IP namespace. In sharp contrast, the GeoInference techniques herein infer structure directly from empirical evidence present in a data stream. Thus, GeoInference requires one fewer dependency. GeoInference's independence from BGP allows GeoInference techniques to find groupings that GeoCluster might not because GeoCluster is restricted to determining groupings defined by prefixes. However, GeoInference can be utilized to find arbitrary address ranges that would otherwise be impossible to determine with GeoCluster's prefix restrictions. GeoInference can also be expanded beyond just IP addresses and locations.

The GeoCluster sub-clustering algorithm appears to function on the basis of an is GeographicallyClustered measure that is utilized recursively to determine whether to split a candidate-cluster into smaller units, subject to a minimum unit-size. In sharp contrast, GeoInference groupings are built-up utilizing the smallest possible units and an isLike function to determine candidate joins, which can enlarge the initial grouping. By comparing small neighboring ranges, the inference techniques are intrinsically sensitive to localized data anomalies. For example, for a proxy IP with significant traffic, the GeoInference techniques are capable of efficiently recognizing a single IP as inferring a unique geographical distribution. Thus, whereas the GeoCluster with sub-clustering employs a top-down approach, GeoInference employs a bottom-up approach.

However, the bottom-up GeoInference algorithm provides intrinsic benefits over GeoCluster in both accuracy and efficiency. A simple implementation of is GeographicallyClustered makes a flat evaluation over the entire candidate-space, allowing localized data anomalies to be lost in the overall noise. This yields an undesirable loss of accuracy. Alternatively, an implementation capable of distinguishing localized data anomalies requires either a linear scan or a binary-recursive scan, yielding an undesirable loss of efficiency. Thus, although appearances suggest that both GeoCluster and GeoInference are capable of deriving similar high-fidelity results from similar data sets, GeoInference's bottom-up approach to building groups can be more computationally efficient when striving for high-fidelity mappings.

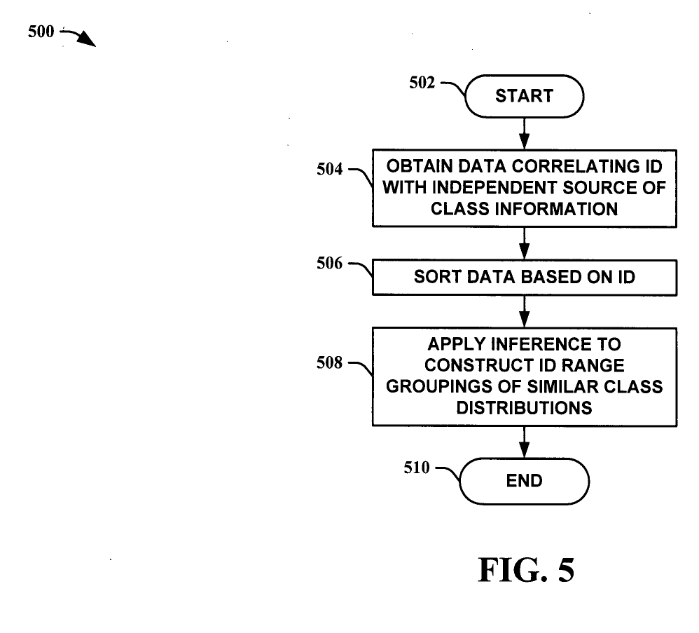

In view of the exemplary systems shown and described above, methodologies that may be implemented in accordance with the embodiments will be better appreciated with reference to the flow charts of FIGS. 5-8. While, for purposes of simplicity of explanation, the methodologies are shown and described as a series of blocks, it is to be understood and appreciated that the embodiments are not limited by the order of the blocks, as some blocks may, in accordance with an embodiment, occur in different orders and/or concurrently with other blocks from that shown and described herein. Moreover, not all illustrated blocks may be required to implement the methodologies in accordance with the embodiments.

The embodiments may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the embodiments.

In FIG. 5, a flow diagram of a method 500 of facilitating ID range-to-class inference in accordance with an aspect of an embodiment is shown. The method 500 starts 502 by obtaining data correlating an ID with an independent source of class information 504. Classes can include, but are not limited to, user location, age, income, gender, language, and/or other classifications. Identifications (IDs) can include, but are not limited to, Internet Protocol (IP) addressing, telephone numbers, and other sequenceable forms of identification for users and/or computing devices. The independent source of class information can be, for example, a log that has data regarding a particular user's name, age, location, etc. in relation to an ID and the like. The data is then sorted based on the ID 506. This can include sorting according to the ID in ascending or descending order or another logical means. An inference is then applied to construct ID range groupings of similar class distributions 508, ending the flow 510. The inference can include, for example, an isLike function that compares neighboring ID ranges to determine the similarity of their class information. Like ranges can be grouped together to form larger ID ranges when similarities exist.

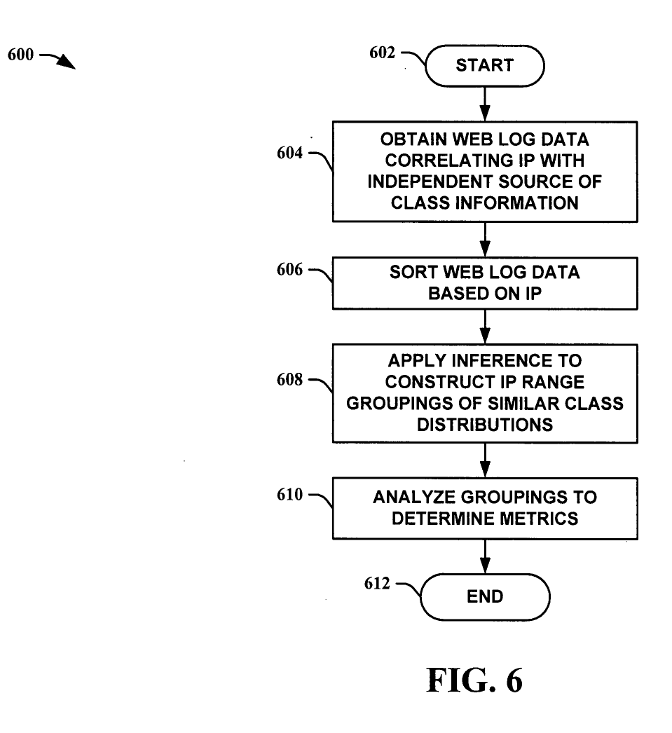

Looking at FIG. 6, a flow diagram of a method 600 of facilitating IP range-to-class inference for web log data in accordance with an aspect of an embodiment is depicted. The method 600 starts 602 by obtaining web log data correlating an IP with an independent source of class information 604. The independent source of class information can be directly and/or indirectly obtained data regarding a particular user. Direct sources can include, for example, information entered during a web site access registration process and the like by the user. Indirect information can include, for example, user information provided by a user data management service utilized by a user that automatically supplies relevant data to a web log and the like.

The web log data is then sorted based on the IP 606. The data presented by an IP can vary depending on the IP standard utilized. For example, the IPv4 standard consists of four octet long IP addresses while the IPv6 consists of 14 octet long addresses. IP's can be ordered in ascending or descending order. An inference is applied to construct IP range groupings of similar class distributions 608. The inference can include, for example, an isLike function that compares neighboring IP ranges to determine the similarity of their class information. Like IP ranges can then be grouped together to form larger IP ranges when similarities exist. The groupings are then analyzed to determine metrics 610, ending the flow 612. The metrics can include, for example, confidence levels, error data, and/or other statistical data and the like.

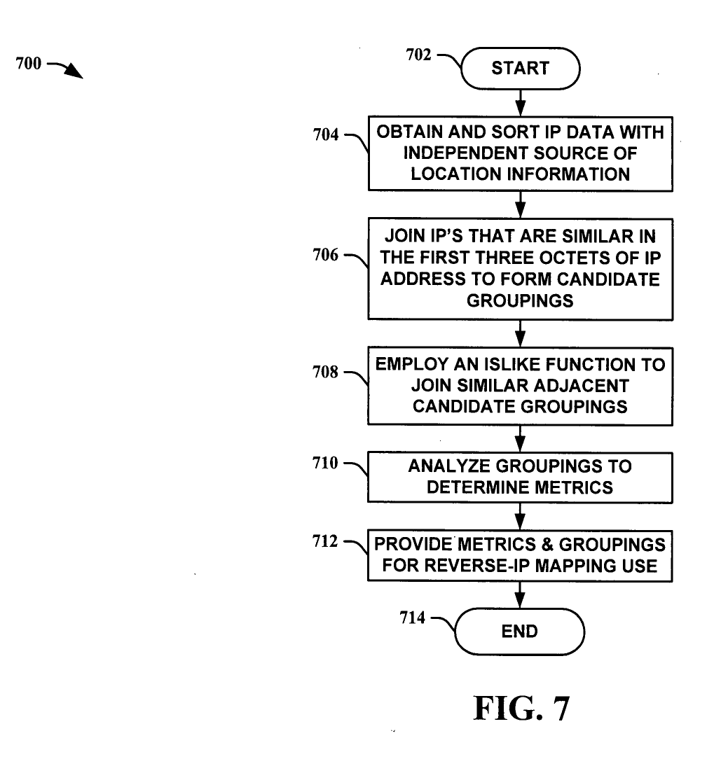

Turning to FIG. 7, a flow diagram of a method 700 of facilitating IP range-to-class inference based on IP octets in accordance with an aspect of an embodiment is illustrated. The method 700 starts 702 by obtaining and sorting IP data with an independent source of location information 704. In this instance, IP ranges are mapped to location as the class of interest. IP's that are similar in the first three octets of an IP address are then joined to form candidate groupings 706. This gives initial groupings that can be compared to each other. An isLike function is then employed to join similar adjacent candidate groupings 708. The isLike function employs a measure or measures to compare the candidate groupings to determine like candidate groupings. The groupings are then analyzed to determine metrics 710. The metrics can include, for example, confidence levels, error data, and/or other statistical data and the like. The metrics and groupings are then provided for reverse-IP mapping use 712, ending the flow 714. This type of data is extremely useful in advertising processes that employ targeted advertisements, in directed searches that return location relevant results, and/or in filtering information and the like based on locale.

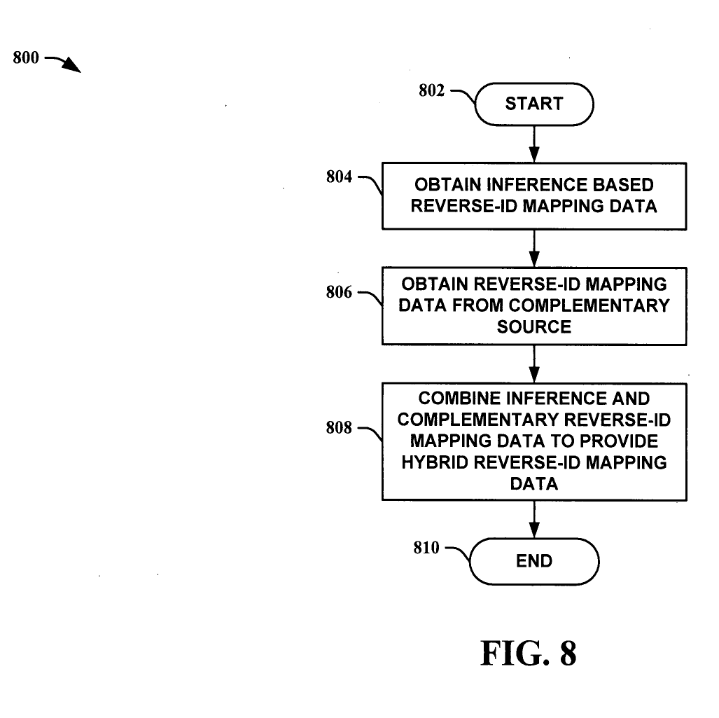

Moving on to FIG. 8, a flow diagram of a method 800 of facilitating ID range-to-class inference hybrid mapping data in accordance with an aspect of an embodiment is shown. The method 800 starts 802 by obtaining inference based reverse-ID mapping data 804. This type of data can be obtained via methods described supra and/or from stored data sources and the like. Reverse-ID mapping data from a complementary source is also obtained 806. This type of data can include, but is not limited to, commercially available reverse-IP mapping data and the like. The inference and complementary reverse-ID mapping data is then combined to provide hybrid reverse-ID mapping data 808, ending the flow 810. Various methods of combining the data types can be employed. Combinations can be implemented to provide missing data of the inference based reverse-ID mapping data with the complementary reverse-ID mapping data and/or to enhance the ID range groupings of the inference based reverse-ID mapping data and the like. For example, if the ID range groupings determined by the inference based reverse-ID mapping data have a low confidence associated with it, the low confidence data can be replaced with data from the complementary reverse-ID mapping data if it has a high level of confidence associated with it. One skilled in the art can appreciate that any number of statistical means can be utilized to facilitate in determining the hybrid reverse-ID mapping data and are within the scope of the methods disclosed herein.

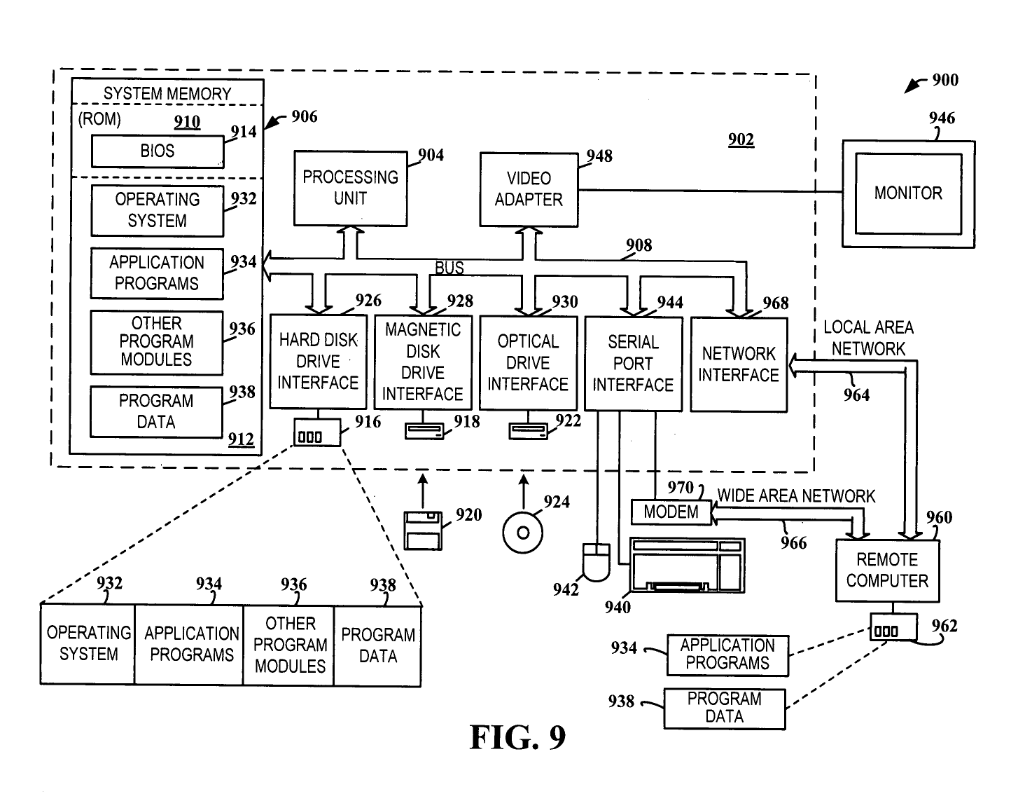

In order to provide additional context for implementing various aspects of the embodiments, FIG. 9 and the following discussion is intended to provide a brief, general description of a suitable computing environment 900 in which the various aspects of the embodiments can be performed. While the embodiments have been described above in the general context of computer-executable instructions of a computer program that runs on a local computer and/or remote computer, those skilled in the art will recognize that the embodiments can also be performed in combination with other program modules. Generally, program modules include routines, programs, components, data structures, etc., that perform particular tasks and/or implement particular abstract data types. Moreover, those skilled in the art will appreciate that the inventive methods can be practiced with other computer system configurations, including single-processor or multi-processor computer systems, minicomputers, mainframe computers, as well as personal computers, hand-held computing devices, microprocessor-based and/or programmable consumer electronics, and the like, each of which can operatively communicate with one or more associated devices. The illustrated aspects of the embodiments can also be practiced in distributed computing environments where certain tasks are performed by remote processing devices that are linked through a communications network. However, some, if not all, aspects of the embodiments can be practiced on stand-alone computers. In a distributed computing environment, program modules can be located in local and/or remote memory storage devices.

With reference to FIG. 9, an exemplary system environment 900 for performing the various aspects of the embodiments include a conventional computer 902, including a processing unit 904, a system memory 906, and a system bus 908 that couples various system components, including the system memory, to the processing unit 904. The processing unit 904 can be any commercially available or proprietary processor. In addition, the processing unit can be implemented as multi-processor formed of more than one processor, such as can be connected in parallel.

The system bus 908 can be any of several types of bus structure including a memory bus or memory controller, a peripheral bus, and a local bus using any of a variety of conventional bus architectures such as PCI, VESA, Microchannel, ISA, and EISA, to name a few. The system memory 906 includes read only memory (ROM) 910 and random access memory (RAM) 912. A basic input/output system (BIOS) 914, containing the basic routines that help to transfer information between elements within the computer 902, such as during start-up, is stored in ROM 910.

The computer 902 also can include, for example, a hard disk drive 916, a magnetic disk drive 918, e.g., to read from or write to a removable disk 920, and an optical disk drive 922, e.g., for reading from or writing to a CD-ROM disk 924 or other optical media. The hard disk drive 916, magnetic disk drive 918, and optical disk drive 922 are connected to the system bus 908 by a hard disk drive interface 926, a magnetic disk drive interface 928, and an optical drive interface 930, respectively. The drives 916-922 and their associated computer-readable media provide nonvolatile storage of data, data structures, computer-executable instructions, etc. for the computer 902. Although the description of computer-readable media above refers to a hard disk, a removable magnetic disk and a CD, it should be appreciated by those skilled in the art that other types of media which are readable by a computer, such as magnetic cassettes, flash memory, digital video disks, Bernoulli cartridges, and the like, can also be used in the exemplary operating environment 900, and further that any such media can contain computer-executable instructions for performing the methods of the embodiments.

A number of program modules can be stored in the drives 916-922 and RAM 912, including an operating system 932, one or more application programs 934, other program modules 936, and program data 938. The operating system 932 can be any suitable operating system or combination of operating systems. By way of example, the application programs 934 and program modules 936 can include an ID range-to-class inference scheme in accordance with an aspect of an embodiment.

A user can enter commands and information into the computer 902 through one or more user input devices, such as a keyboard 940 and a pointing device (e.g., a mouse 942). Other input devices (not shown) can include a microphone, a joystick, a game pad, a satellite dish, a wireless remote, a scanner, or the like. These and other input devices are often connected to the processing unit 904 through a serial port interface 944 that is coupled to the system bus 908, but can be connected by other interfaces, such as a parallel port, a game port or a universal serial bus (USB). A monitor 946 or other type of display device is also connected to the system bus 908 via an interface, such as a video adapter 948. In addition to the monitor 946, the computer 902 can include other peripheral output devices (not shown), such as speakers, printers, etc.

It is to be appreciated that the computer 902 can operate in a networked environment using logical connections to one or more remote computers 960. The remote computer 960 can be a workstation, a server computer, a router, a peer device or other common network node, and typically includes many or all of the elements described relative to the computer 902, although for purposes of brevity, only a memory storage device 962 is illustrated in FIG. 9. The logical connections depicted in FIG. 9 can include a local area network (LAN) 964 and a wide area network (WAN) 966. Such networking environments are commonplace in offices, enterprise-wide computer networks, intranets and the Internet.

When used in a LAN networking environment, for example, the computer 902 is connected to the local network 964 through a network interface or adapter 968. When used in a WAN networking environment, the computer 902 typically includes a modem (e.g., telephone, DSL, cable, etc.) 970, or is connected to a communications server on the LAN, or has other means for establishing communications over the WAN 966, such as the Internet. The modem 970, which can be internal or external relative to the computer 902, is connected to the system bus 908 via the serial port interface 944. In a networked environment, program modules (including application programs 934) and/or program data 938 can be stored in the remote memory storage device 962. It will be appreciated that the network connections shown are exemplary and other means (e.g., wired or wireless) of establishing a communications link between the computers 902 and 960 can be used when carrying out an aspect of an embodiment.

In accordance with the practices of persons skilled in the art of computer programming, the embodiments have been described with reference to acts and symbolic representations of operations that are performed by a computer, such as the computer 902 or remote computer 960, unless otherwise indicated. Such acts and operations are sometimes referred to as being computer-executed. It will be appreciated that the acts and symbolically represented operations include the manipulation by the processing unit 904 of electrical signals representing data bits which causes a resulting transformation or reduction of the electrical signal representation, and the maintenance of data bits at memory locations in the memory system (including the system memory 906, hard drive 916, floppy disks 920, CD-ROM 924, and remote memory 962) to thereby reconfigure or otherwise alter the computer system's operation, as well as other processing of signals. The memory locations where such data bits are maintained are physical locations that have particular electrical, magnetic, or optical properties corresponding to the data bits.

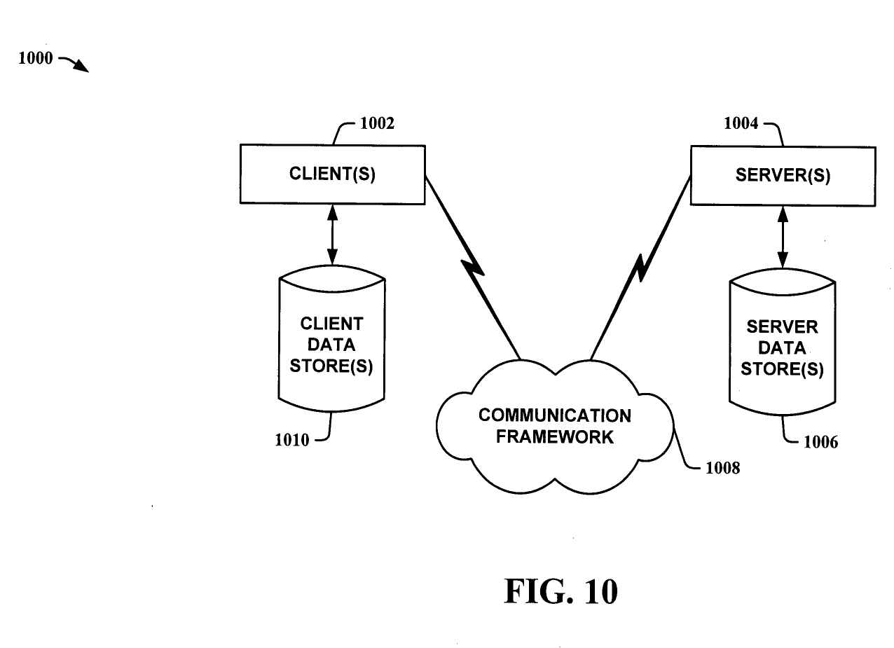

FIG. 10 is another block diagram of a sample computing environment 1000 with which embodiments can interact. The system 1000 further illustrates a system that includes one or more client(s) 1002. The client(s) 1002 can be hardware and/or software (e.g., threads, processes, computing devices). The system 1000 also includes one or more server(s) 1004. The server(s) 1004 can also be hardware and/or software (e.g., threads, processes, computing devices). One possible communication between a client 1002 and a server 1004 can be in the form of a data packet adapted to be transmitted between two or more computer processes. The system 1000 includes a communication framework 1008 that can be employed to facilitate communications between the client(s) 1002 and the server(s) 1004. The client(s) 1002 are connected to one or more client data store(s) 1010 that can be employed to store information local to the client(s) 1002. Similarly, the server(s) 1004 are connected to one or more server data store(s) 1006 that can be employed to store information local to the server(s) 1004.

It is to be appreciated that the systems and/or methods of the embodiments can be utilized in ID range-to-class inference facilitating computer components and non-computer related components alike. Further, those skilled in the art will recognize that the systems and/or methods of the embodiments are employable in a vast array of electronic related technologies, including, but not limited to, computers, servers and/or handheld electronic devices, and the like.

What has been described above includes examples of the embodiments. It is, of course, not possible to describe every conceivable combination of components or methodologies for purposes of describing the embodiments, but one of ordinary skill in the art may recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates a identification (ID) range-to-class inference, comprising:
a receiving component that receives class and associated identification (ID) information; and
an inference component that infers at least one ID range-to-class grouping based on, at least in part, a distribution of a user class associated with the identification information.

2. The system of claim 1, the inference component employs an isLike function to facilitate in determining the ID range-to-class grouping.

3. The system of claim 1, the identification (ID) comprising an Internet Protocol (IP) address and/or a telephone number.

4. The system of claim 1, the class comprising geographic location of a user, age of a user, income of a user, gender of a user, and/or language of a user.

5. The system of claim 1 further comprising:
a pre-filtering component that sorts and/or filters the class and associated identification (ID) information from the receiving component and provides it to the inference component.

6. The system of claim 1 further comprising:
an analysis component that determines metrics associated with the ID range-to-class grouping.

7. The system of claim 1 further comprising:
a data combining component that combines ID range-to-class groupings with complementary ID range-to-class mapping data to facilitate in providing hybrid mapping data.

8. The system of claim 1, the class and associated identification (ID) information comprising Internet web log information.

9. An advertising mechanism that employs the system of claim 1 to facilitate in targeting advertisements to users.

10. A method for facilitating identification (ID) range-to-class inference, comprising:
obtaining data correlating identification (ID) with an independent source of information relating to a user class;
sorting the data based on the identification (ID); and
applying an inference to construct at least one ID range-to-class grouping of similar class distributions.

11. The method of claim 10 further comprising:
employing an isLike function to facilitate in determining the ID range-to-class grouping.

12. The method of claim 10 further comprising:
utilizing an Internet Protocol (IP) addressing scheme as the identification (ID) to facilitate in determining an ID range-to-class grouping.

13. The method of claim 12 further comprising:
joining IP's that are similar in a sequence of octets of an IP address to form candidate groupings; and
evaluating the candidate groupings utilizing an isLike function to join similar candidate groupings.

14. The method of claim 10 further comprising:
employing geographic location of a user as the user class to facilitate in determining an ID range-to-class grouping.

15. The method of claim 10, the data comprising Internet web log data.

16. The method of claim 10 further comprising:
analyzing an ID range-to-class grouping to determine metrics associated with the grouping.

17. The method of claim 10 further comprising:
obtaining reverse-ID mapping data from a complementary data source; and
combining at least one ID range-to-class grouping with the complementary reverse-ID mapping data to construct hybrid reverse-ID mapping data.

18. A system that facilitates identification (ID)-to-class range inference, comprising:
means for receiving class and associated identification (ID) information; and
means for inferring at least one ID range-to-class grouping based on, at least in part, a distribution of a user class associated with the identification information.

19. A device employing the method of claim 10 comprising at least one selected from the group consisting of a computer, a server, and a handheld electronic device.

20. A device employing the system of claim 1 comprising at least one selected from the group consisting of a computer, a server, and a handheld electronic device.
